(19) United States
(12) Patent Application Publication
(10) Pub. No.: US 2009/0304093 A1
(43) Pub. Date: Dec. 10, 2009

(54) TRANSMITTING DEVICE, COMMUNICATION SYSTEM AND METHOD USING A MEDIUM

(75) Inventors: Han Bo Shim, Seongnam-si (KR); Jung Jin Hwang, Daejeon (KR); Won Woo Cho, Yongin-si (KR)

Correspondence Address: Workman Nydegger;1000 Eagle Gate Tower, 60 East South Temple, Salt Lake City, UT, 84111, US

(73) Assignee: INTROMEDIC. CO., LTD, Seoul (KR)

(21) Appl. No.: 12/375,628

(22) PCT Filed: Aug. 1, 2006
(86) PCT No.: PCT/KR06/03028

§ 371 Date: Jan. 29, 2009

(51) Int. Cl. H04L 27/00

(52) U.S. Cl. 375/259

(57) ABSTRACT

A transmitting apparatus, a communication system, and a communication method, using a medium, are disclosed. The transmitting apparatus includes an information processing unit for acquiring information about the medium and converting the information into an electric signal, a transmitting electrode for receiving the electric signal and transmitting the electric signal to a receiving electrode provided at the exterior of the medium, and an insulating member for forming a capacitor with the transmitting electrode and the medium, wherein the transmitting electrode transmits the electric signal to the receiving electrode through an electric field generated by the insulating member. Therefore, the electric signal can be safely transmitted through a human body using the electric field.

### TECHNICAL FIELD

The invention relates to a transmitter, a communication system, and a communication method, respectively using a medium.

### BACKGROUND ART

A conventional method of transmitting information about the inside of a human body to the exterior will be described as follows.

Generally, there is a communication cable type information transmitting method to be applied to an endoscope that is developed for the purpose of inspecting the inside of a stomach. In this type of information transmitting method, a cable made of conductive wires or an optical fiber is inserted into the human body through throat of a patient to inspect the patient's stomach.

However, in the communication cable type information transmitting method, the patient to be inspected with the endoscope suffers severe pain.

In order to solve the problem, a capsule type endoscope is developed.

The capsule type endoscope is a device for transmitting image data of the inside of the human body captured by a camera module of the capsule type endoscope to an external information receiver when the patient swallows the capsule type endoscope like a medical tablet.

However, since the capsule type endoscope uses radio frequency to transmit information, high power consumption shortens the operating time of the capsule type endoscope, the receive sensitivity is inferior due to interference of various external electromagnetic waves of the human body, and a modulating circuit for converting an image signal into a radio frequency signal and an antenna for transmitting the signals are required so that volume of an apparatus for transmitting and receiving the signals is increased.

### DISCLOSURE OF INVENTION

Therefore, the present invention has been made in view of the above problems, and it is an aspect of the present invention to provide a transmitting apparatus for transmitting information about a human body to the external apparatus via the human body as a medium.

It is another aspect of the present invention to provide a transmitting apparatus for transmitting information about a medium without an antenna for converting an image signal into a radio frequency signal or for transmitting a signal.

It is still another aspect of the present invention to provide a transmitting apparatus for converting an electric signal without demodulation into a radio frequency signal.

It is still another aspect of the present invention to provide a transmitting apparatus for transmitting an electric signal in a circumstance harmless to human.

In accordance with an aspect of the present invention, the above and other objects can be accomplished by the provision of a transmitting apparatus using a medium including: an information processing unit for acquiring information about the medium and converting the information into an electric signal; a transmitting electrode for receiving the electric signal and transmitting the electric signal to a receiving electrode provided at the exterior of the medium; and an insulating member for forming a capacitor with the transmitting electrode and the medium; wherein the transmitting electrode transmits the electric signal to the receiving electrode through an electric field generated by the insulating member.

Moreover, the transmitting apparatus further claim 15.

In accordance with an aspect of the present invention, the above and other objects can be accomplished by the provision of a communication system using a medium including: a transmitting apparatus for converting acquired information about the medium into an electric signal and for transmitting the electric signal to the medium through an electric field generated by an insulating member that forms a capacitor with the medium and the transmitting apparatus; and a receiving apparatus for detecting the electric signal using plural receiving electrodes provided at the exterior of the medium.

In accordance with an aspect of the present invention, the above and other objects can be accomplished by the provision of a communication method using a medium including: acquiring information about the medium; converting the acquired information into an electric signal; generating an electric field between a transmitting electrode and the medium; and transmitting the electric signal to a receiving electrode provided at the exterior of the medium through the electric field.

According to the present invention, since the electric signal is transmitted by electric field without electric current flowing directly through a human body, the transmitting apparatus is safe to the human body.

Moreover, since low frequencies harmful to the human body are intercepted, the transmitting apparatus is safe to the human body.

Additionally, according to the present invention, the transmitting antenna is not required and the electric signal can be safely transmitted to the exterior only by a simple electrode.

According to the present invention, the receiving apparatus can easily restore the transmitted electric signal.

According to the present invention, the high speed communication is enabled at frequency band lower than the radio frequency.

According to the present invention, since a RF demodulation module is not required, power consumption is reduced.

### BRIEF DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention.

In the drawings:

FIG. 1 is a diagrammatic view of a transmitting apparatus using a medium according to an embodiment of the present invention;

FIG. 2 is a sectional view illustrating the transmitting apparatus using a medium according to the embodiment of the present invention;

FIG. 3 is a perspective view illustrating the transmitting apparatus using a medium according to the embodiment of the present invention;

FIG. 4 is a diagrammatical view illustrating a transmitting apparatus using a medium according to another embodiment of the present invention;

FIG. 5 is a sectional view illustrating the transmitting apparatus using a medium according to another embodiment of the present invention;

FIG. 6 is a perspective view illustrating the transmitting apparatus using a medium according to another embodiment of the present invention;

FIG. 7 is a view illustrating the transmitting apparatus according to the present invention located in human body;

FIG. 8 is a view illustrating electric field generated in the human body by the transmitting apparatus according to the present invention;

FIG. 9 is a graph illustrating intensity of the electric field at respective portions of the transmitting apparatus according to the present invention;

FIG. 10 is a view schematically illustrating the connection between the transmitting apparatus according to the present invention and a receiving electrode;

FIG. 11 is a view illustrating the connection between the transmitting apparatus according to the present invention and the receiving electrode in detail;

FIG. 12 is a view illustrating a first example of the arrangement of the transmitting electrode in the transmitting apparatus according to the present invention;

FIG. 13 is a view illustrating a second example of the arrangement of the transmitting electrode in the transmitting apparatus according to the present invention;

FIG. 14 is a view illustrating a third example of the arrangement of the transmitting electrode in the transmitting apparatus according to the present invention;

FIG. 15 is a view illustrating a fourth example of the arrangement of the transmitting electrode in the transmitting apparatus according to the present invention;

FIG. 16 is a view illustrating a fifth example of the arrangement of the transmitting electrode in the transmitting apparatus according to the present invention;

FIG. 17 is a view illustrating a sixth example of the arrangement of the transmitting electrode in the transmitting apparatus according to the present invention;

FIG. 18 is a diagrammatic view illustrating a communication system using a medium according to an embodiment of the present invention;

FIG. 19 is a diagrammatic view illustrating a receiving apparatus according to an embodiment of the present invention;

FIG. 20 is a flowchart illustrating a communication method using a medium according to an embodiment of the present invention; and

FIG. 21 is a flowchart illustrating a communication method using a medium according to another embodiment of the present invention.

### BEST MODE FOR CARRYING OUT THE INVENTION

Hereinafter, preferred embodiments of the present invention capable of implanting the above objects and features of the present invention will be described in detail with reference to the accompanying drawings. Moreover, in the following description of the present invention, if the detailed description of the already known structure and operation may confuse the subject matter of the present invention, the detailed description thereof will be omitted.

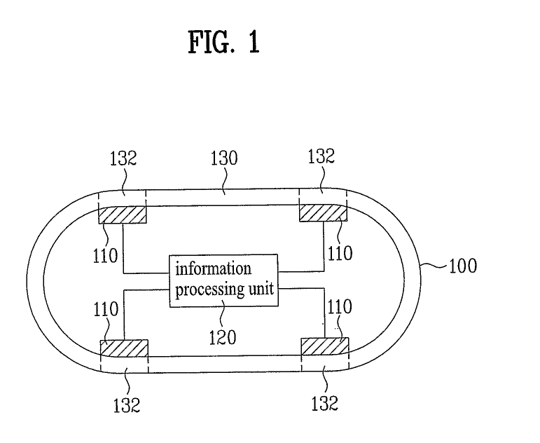

Referring to FIG. 1, a transmitting apparatus 100 using a medium according to an embodiment of the present invention will be described in detail.

As shown in FIG. 1, the transmitting apparatus 100 includes an information processing unit 120 for obtaining and processing information about a medium, transmitting electrodes 110 for transmitting the processed information, and an outer member 130 for enclosing internal components of the transmitting apparatus 100.

Particularly, insulating members 132 as parts of the outer member 130 forms capacitors between the transmitting electrodes 110 and a medium and generate electric fields.

Meanwhile, although not depicted in FIG. 1, the transmitting apparatus 100 further includes an error corrector (not shown) for adding redundant bit to the electric signal for the correction of error, a parallel/serial converter (not shown) for converting a parallel signal, that is, the error-corrected electric signal into a serial signal, and an encoder (not shown) for encoding the converted electric signal into a predetermined code.

The information processing unit 120 acquires information about the medium and converts the acquired information into an electric signal.

The medium may be a high resistance substance such as a human body, water, an aqueous solution in which some chemical substance is dissolved, and so on.

The information about the medium contains image information, sound information, information about constituent substances of the medium, and the like.

For example, when the medium is the human body, the information about the medium may contain image information about the inside of the human body, sound information, and analysis result of materials existing in the human body.

The information processing unit 120 includes a plurality of sensors for acquiring information about the medium.

The sensors include an image sensor for acquiring image information about the medium, a sound sensor for acquiring sound information about the medium, a temperature sensor for measuring temperature of the medium, and a pH sensor for measuring pH of the medium.

The transmitting electrodes 110 receive the electric signals from the information processing unit 120 and transmit the electric signals to a receiving electrode provided at the exterior of the medium. In this case, the insulating members 132 form capacitors with the transmitting electrodes 110 and the medium.

Particularly, in the present invention, the transmitting electrodes 110 transmit the electric signals to the receiving electrode using the electric fields generated by the insulating members 132.

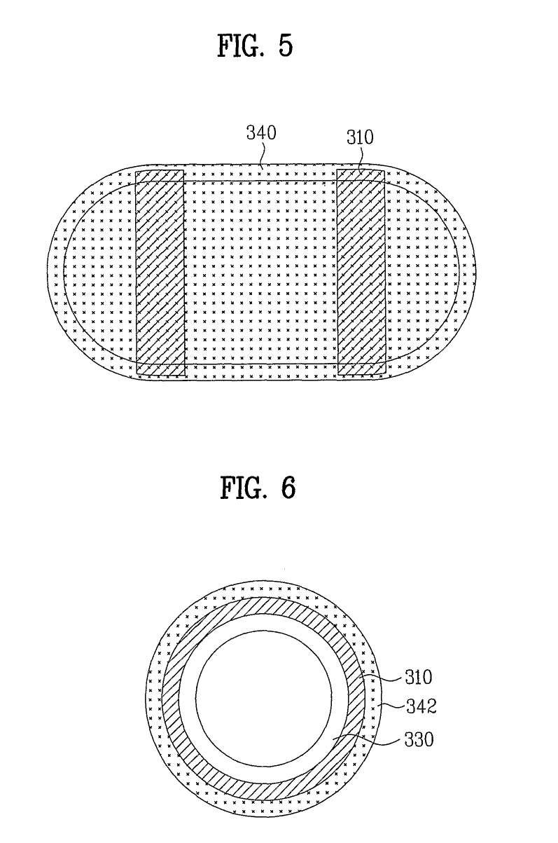

When the medium is the human body, the transmitting apparatus 500 according to the present invention, is located in the human body as shown in FIG. 5, and transmits the electric signal to the human body through the transmitting electrode installed therein. The electric signal transmitted to the human body is transmitted to the receiving electrode by the electric field.

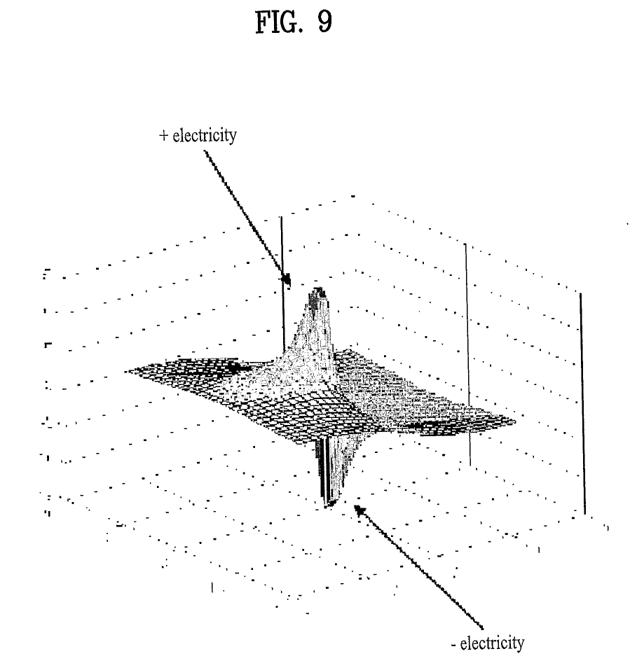

Moreover, as shown in FIG. 8, the transmitting apparatus 100 generates electric fields around the transmitting electrodes 110 whereby the electric fields extend to the receiving electrodes 510 provided at the exterior of the human body. FIG. 9 is a view illustrating intensity of the electric fields generated by the transmitting apparatus 100. As shown in FIG. 9, it is noted that the strongest electric fields are generated at the surrounding of the transmitting electrodes 110. Thus, the electric signals are transmitted from the transmitting electrodes 110 to the receiving electrodes 510 by the electric fields. If plural receiving electrodes are provided, the electric fields generate potential differences at the respective receiving electrodes 510.

When plural transmitting electrodes 110 are provided, each of the transmitting electrodes 110 has different voltage.

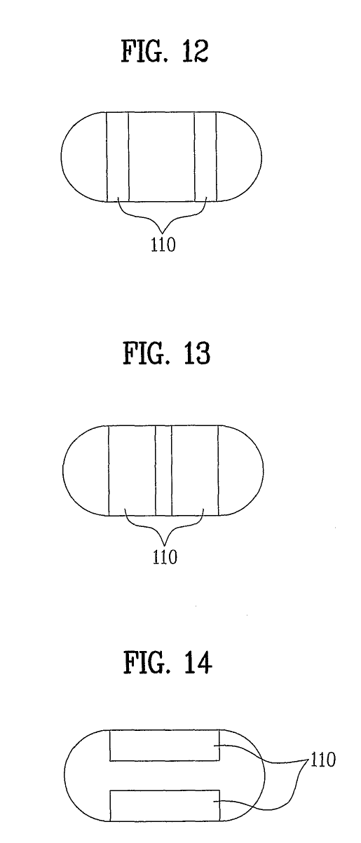

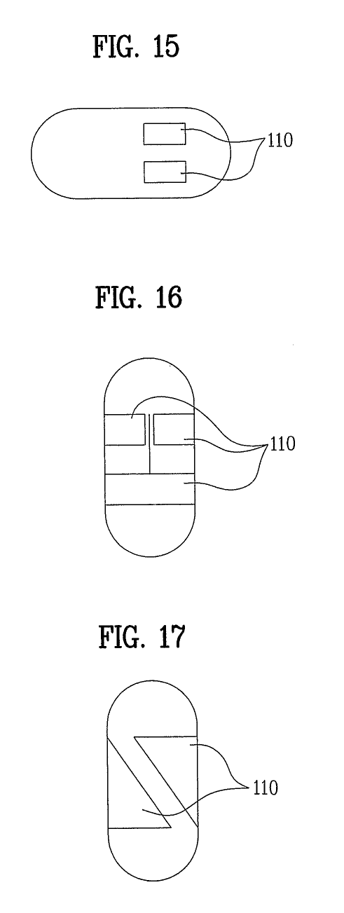

FIGS. 12, 13, 14, 15, 16, and 17 illustrate various embodiments of the arrangement of the plural transmitting electrodes 110 in the transmitting apparatus 100.

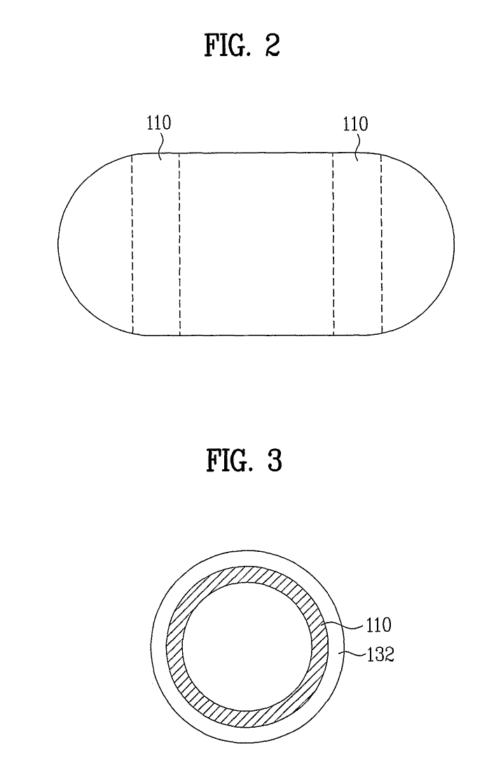

As shown in FIG. 3, if distances between the transmitting electrodes 110 are sufficiently long so as to separate the transmitting electrodes electrically, the plural transmitting electrodes 110 may be provided at any place inside the outer member 130. Moreover, since the transmitting electrodes 110 are made of conductive material and may be exposed to the medium, the transmitting electrodes 110 are made of material uncreative with to reactant and harmless to the human body.

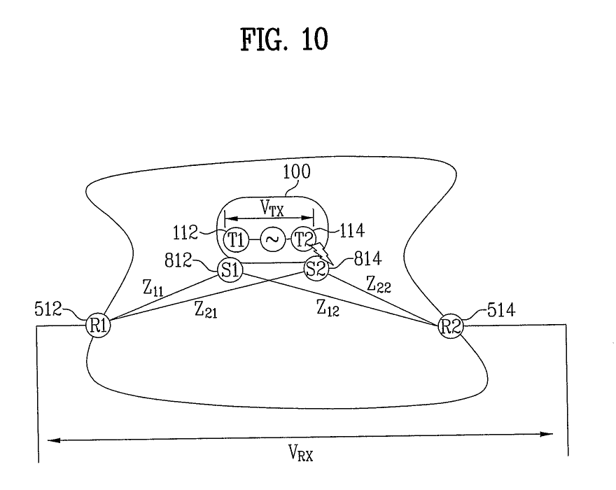

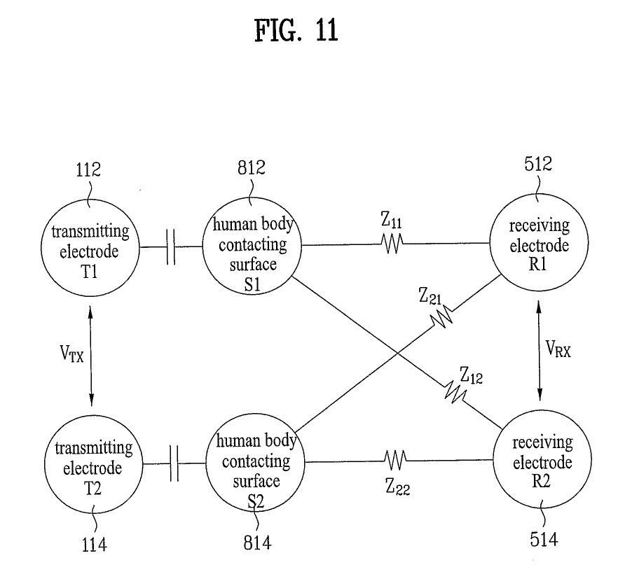

The receiving electrodes are attached to the outer sides of the medium and transmit the electric signals to the external receiving apparatus. When plural receiving electrodes are provided, the plural receiving electrodes have different voltages, respectively. This will be described later in detail with reference to FIGS. 10 and 11.

The insulating members 132 are parts of the outer member 130. In other words, the insulating members 132 may be portions of the outer member 130 contacting the transmitting electrodes 110. This is because the insulating members 132 form capacitors with the transmitting electrodes 110 and the medium.

As shown in FIG. 2, the transmitting electrodes 110 are provided at the inner surface of the outer member 130, and portions of the outer member 130 contacting the transmitting electrodes 110 serve as the insulating member 132.

Since the outer member 130 is provided at the outermost side of the transmitting apparatus 100 to enclose the inner components of the transmitting apparatus 100, it is preferred that the outer member 130 is made of nonconductor that is harmless to human body and through which an electric current does not flow.

Meanwhile, the transmitting apparatus 100 may further include a coating member (not shown) for coating overall outer side of the outer member 130. In this case, the insulating members 132 may be parts of the outer member and the coating member. The coating members must be nonconductors harmless to the human body.

Additionally, the insulating members 132 form capacitors with the transmitting electrodes and the medium.

Hereinafter, how the insulating members 132 form capacitors and impedance is varied with frequency will be described in detail.

For example, if thicknesses of the insulating members 132 are 0.0005 m, relative dielectric constant 3.15 (dielectric constant is 3.15*8.8542*10⁻¹², where 8.8542*10⁻¹² is dielectric constant of vacuum) of constituent substances of the insulating members 312, areas of the transmitting electrodes 110 are 0.0002 m², capacitance due to the insulating members 132 is estimated as follows.

$$C = ɛ \times \frac{S}{D} \qquad [ Formula 1 ]$$

where, C [F] is capacitance, ∈ is a dielectric constant, S [m2] is an area of an electrode plate, and D [m] is a distance between two electrode plates.

Thus, the capacitance of the insulating member 132 estimated by the formula 1 is 11.16 pF.

Moreover, for example, impedance due to the insulating members 132 at a specific frequency is estimated as follows.

$$Z = \frac{1}{2 π fC} \qquad [ Formula 2 ]$$

where, Z [Ω] is the impedance due to the capacitor, f [Hz] is frequency, and C [F] is capacitance.

If the frequency is 1 MHz, the impedance of the insulating members 132 estimated by the formula 2 is 14.3 kΩ. If the frequency is 10 MHz, the impedance of the insulating members 132 estimated by the formula 2 is 1.43 kΩ. In other words, it is noted that the estimated impedance is inversely proportional to the frequency. Thus, since the insulating members 132 have impedance lower than a predetermined value at a frequency higher than a predetermined frequency, the impedance can be reduced by properly adjusting the frequency. In other words, since the insulating members 132 have high impedance at a frequency lower than the predetermined frequency, the insulating members 132 can serve as high pass filters.

For example, when the frequency is higher than 20 MHz, signals can be transmitted to the exterior only by providing the transmitting electrodes with plated interior.

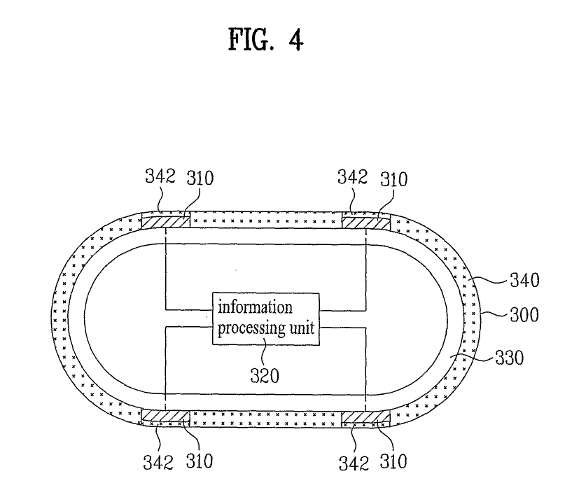

A transmitting apparatus 300 using a medium according to another embodiment of the present invention will be described in detail with reference to FIG. 4 as follows.

As shown in FIG. 4, the transmitting apparatus 300 includes an information processing unit 320 for acquiring and processing information about the medium, transmitting electrodes 310 for transmitting the processed information, and an outer member 330 provided to enclose internal components of the transmitting apparatus 300. The transmitting electrodes 310 are provided at the outer surface of the outer member 330.

Moreover, the transmitting apparatus 300 further includes a coating member 340 for coating overall outer side of the transmitting apparatus 300. In this case, insulating members 342 forming parts of the coating member 340 form capacitors with the transmitting electrodes 310 and the medium, and generate electric fields at the surroundings thereof. The coating member 340 is preferably made of a nonconductor harmless to the human body such as parylene and its thickness may be changed according to the use of the coating member 340.

Meanwhile, although not depicted in FIG. 4, the transmitting apparatus 300 further includes an error corrector (not shown) for adding redundant bit to the electric signal for the correction of error, a parallel/serial converter (not shown) for converting a parallel signal, that is, the error-corrected electric signal into a serial signal, and an encoder (not shown) for encoding the converted electric signal into a predetermined code.

The information processing unit 320 acquires information about the medium and converts the acquired information into an electric signal.

Since the information processing unit 320 has the same function and operation as those of the information processing unit 120 in FIG. 1 except for its reference numeral, its detailed description will be omitted.

The outer member 330 is provided to protect and enclose the internal components of the transmitting apparatus 300. However, the transmitting electrodes 310 are provided at the outer surface of the outer member 330.

The transmitting electrodes 310 receive the electric signals from the information processing unit 320 and transmit the electric signal to a receiving electrode provided at the exterior of the medium. At this time, the insulating members 342 form capacitors with the transmitting electrodes 310 and the medium.

Particularly, in the present invention, the transmitting electrodes 310 transmit the electric signals to the receiving electrode through the electric fields generated by the insulating members 342.

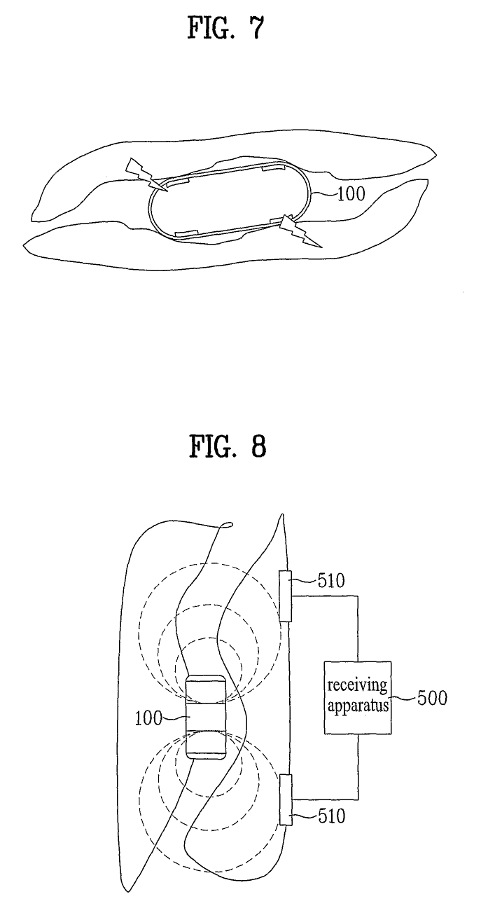

Like the transmitting apparatus 100 according to the present invention is located in the human body in FIG. 7, the transmitting apparatus 300 is located in the human body and transmits the electric signals through the transmitting electrodes provided therein. In this case, the electric signals transmitted to the human body are transmitted to the receiving electrodes by the electric fields.

Moreover, like the transmitting apparatus 100 according to the present invention shown in FIG. 8 generates the electric fields, the transmitting apparatus 300 generates electric fields about the transmitting electrodes 310 whereby the electric fields extend to the receiving electrodes provided at the exterior of the human body. It is noted that the intensity of the electric fields generated by the transmitting apparatus 300, as shown in FIG. 9, shows that the strongest electric fields are generated at the surrounding of the transmitting electrodes 310. Thus, the electric signals are transmitted from the transmitting electrodes 310 to the receiving electrodes 510 by the electric fields. If plural receiving electrodes are provided, the electric fields generate potential differences at the respective receiving electrodes 510. If plural receiving electrodes are provided, the electric fields generate potential differences at the respective receiving electrodes 510.

When plural transmitting electrodes 310 are provided, each of the transmitting electrodes 310 has different voltage.

FIGS. 12, 13, 14, 15, 16, and 17 illustrate various embodiments of the arrangement of the plural transmitting electrodes 310 in the transmitting apparatus 300.

As shown in FIG. 5, if distances between the transmitting electrodes 410 are sufficiently long so as to separate the transmitting electrodes electrically, the plural transmitting electrodes 310 may be provided at any place inside the outer member 330. Moreover, since the transmitting electrodes 310 are made of conductive material and may be exposed to the medium, the transmitting electrodes 110 are made of material no reactive with reactant and harmless to the human body.

The receiving electrodes are attached to the outer sides of the medium and transmit the electric signals to the external receiving apparatus. When plural receiving electrodes are provided, the plural receiving electrodes have different voltages, respectively. This will be described later in detail with reference to FIGS. 10 and 11.

The insulating members 342 are parts of the coating members 340. In other words, the insulating members 342 may be portions of the coating members 342 contacting the transmitting electrodes 310. This is because the insulating members 342 form as capacitors with the transmitting electrodes 310 and the medium.

As shown in FIG. 6, the transmitting electrodes 310 are provided at the outer surface of the outer member 330, and portions of the coating members 340 contacting the transmitting electrodes 310 serve as the insulating member 342.

Additionally, the insulating members 342 form capacitors with the transmitting electrodes 310 and the medium.

Hereinafter, how the insulating members 342 form capacitors and impedance is varied with frequency will be described in detail.

For example, if thicknesses of the insulating members 132 are 1 μm, relative dielectric constant 3.15 (dielectric constant is 3.15*8.8542*10⁻¹², where 8.8542*10⁻¹² is dielectric constant of vacuum) of constituent substances of the insulating members 342, and areas of the transmitting electrodes 310 are 0.0002 m². Capacitance due to the insulating members 342 is estimated as 5.58 nF by the formula 1.

Moreover, for example, the impedance due to the insulating members 342 at a specific frequency is estimated by the formula 2.

If the specific frequency is 1 MHz, the impedance of the insulating members 342 is 28.54Ω. If the specific frequency is 1 kHz, the impedance of the insulating members 342 estimated by the formula 2 is 28.54 kΩ. In other words, it is noted that the estimated impedance is inversely proportional to the frequency. Thus, since the insulating members 342 have impedance lower than a predetermined value at a frequency higher than a predetermined frequency, the impedance can be reduced by properly adjusting the frequency. In other words, since the insulating members 342 have high impedance at a frequency lower than the predetermined frequency, the insulating members 342 can serve as high pass filters for intercepting lower frequencies harmful to the human body.

The connection between the transmitting apparatus according to the present invention and the receiving electrodes will be described in detail with reference to FIGS. 10 and 11 as follows.

The transmitting apparatuses 100 and 300 include the plural transmitting electrodes 112 and 114. The transmitting apparatuses 100 and 300 contact plural human body contacting surfaces 812 and 814 by interposing the insulating members 132 and 342 therebetween.

At that time, the transmitting electrodes 112 and 114 apply displacement current to the insulating members 132 and 342 serving as capacitors and transmit the electric signals using the applied displacement current to the human body contacting surfaces 812 and 814. Otherwise, the transmitting electrodes 112 and 114 may transmit the electric signals to the human body contacting surfaces 812 and 814 using electric fields generated by the displacement current.

Moreover, the plural transmitting electrodes 112 and 114 have respective different voltages and generate electric fields having respective different electric field strengths due to the respective different voltages.

The receiving electrodes 512 and 514 are connected to the human body contacting surfaces 812 and 814 by interposing virtual impedances Z₁₁, Z₁₂, Z₂₁, and Z₂₂ therebetween and receive the electric signals from the transmitting electrodes 112 and 114. Particularly, the receiving electrodes 512 and 514 receive the electric signals using the electric fields generated about the transmitting electrodes 112 and 114.

In the present invention, the receiving electrodes 512 and 514 have slightly different configurations according to frequency characteristics, distances from the transmitting electrodes, and a communication protocol. The receiving electrodes 512 and 514 can be performed by thin film coating similar to the transmitting apparatuses 100 and 300 according to the present invention, and the thin film coating is determined by taking intensity of the signals, the frequency characteristics, and the like into consideration.

Moreover, the receiving electrodes 512 and 514 read voltages due to the variation of the electric fields applied to the human body and transmit the voltages to the external receiving apparatus. In this case, the receiving electrodes 512 and 514 require plural receiving electrodes whose efficiencies are maximal when being located according to the directions of the transmitting electrodes and that receive the electric signals from the transmitting electrodes that may be provided in any direction such as the capsule type endoscope. The plural receiving electrodes 512 and 514 have respective different voltages.

A configuration of a communication system using a medium according to another embodiment of the present invention will be described in detail with reference to FIG. 18 as follows.

As shown in FIG. 18, the communication system according to another embodiment of the present invention includes the transmitting apparatus 100 for converting acquired information about the medium 1100 into electric signals and for transmitting the electric signals to the medium 1100 through electric fields generated by the insulating members serving as capacitors between the transmitting apparatus and the medium 1100, and a receiving apparatus 500 for receiving the electric signals through plural receiving electrodes 512, 514, and 516 that are provided at the exterior of the medium 1100.

Since the transmitting apparatus 100 has been described in detail above with reference to FIG. 1, hereinafter the description thereof will be omitted. Moreover, it is very apparent that the transmitting apparatus 100 may be replaced with the transmitting apparatus 300 shown in FIG. 4.

The medium 1100 may be any substance having a predetermined resistance such as the human body.

The transmitting apparatus 100 transmits the electric signal containing the information about the medium to the plural receiving electrodes 512, 514, and 516 at a specific frequency through the medium 1100. At that time, the plural receiving electrodes 512, 514, and 516 have respective different voltages.

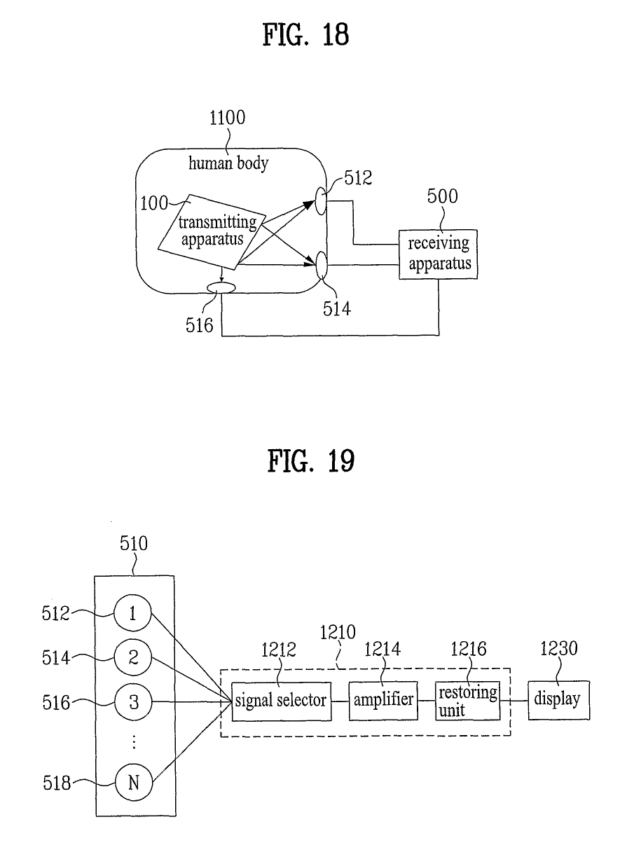

Hereinafter, the receiving apparatus 500 will be described in detail with reference to FIG. 19.

As shown in FIG. 19, the receiving apparatus 500 according to another embodiment of the present invention includes a signal processing unit 210 for converting the electric signal received from the plural receiving electrodes 512, 514, 516, and 518 into information about the medium, and a display 1230 for displaying the information about the medium.

The signal processing unit 1210 includes a signal selector 1212 for selecting a specific signal from the electric signals transmitted from the plural receiving electrodes that are provided at the exterior of the medium, an amplifier 1214 for amplifying the selected electric signal, and a restoring unit 1216 for restoring the amplified electric signal to the original information about the medium.

For example, when two or more electric signals are selected, the amplifier 1214 amplifies the electric signal differentially to detect clearer signals.

The display 1230 can display the restored information about the medium in the form of an image or sound.

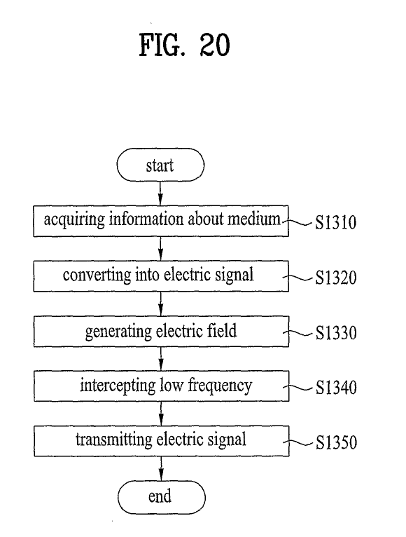

A communication method using a medium according to an embodiment of the present invention will be described in detail with reference to FIG. 20 as follows.

The transmitting apparatus acquires the information about the medium (S1310).

The medium may be a high resistance substance such as a human body, water, an aqueous solution in which some chemical substance is dissolved, and so on. The information about the medium contains image information, sound information, information about constituent substances of the medium, and the like.

For example, when the medium is the human body, the information about the medium may contain image information about the inside of the human body, sound information, and analysis result of materials existing in the human body.

Moreover, the transmitting apparatus includes plural sensors as devices for acquiring the information about the medium. The sensors include an image sensor for acquiring image information about the medium, a sound sensor for acquiring sound information about the medium, a temperature sensor for measuring temperature of the medium, and a pH sensor for measuring pH of the medium.

The transmitting apparatus converts the acquired information about the medium into electric signals (S1320).

The transmitting apparatus generates electric fields between the transmitting apparatus and the medium (S1330).

The transmitting apparatus generates the electric fields about the transmitting electrodes whereby the electric fields extend to the receiving electrodes provided at the exterior of the human body. In this case, the transmitting electrodes may be provided in or out of the outer member for enclosing the transmitting apparatus.

For example, when the transmitting electrodes are provided in the outer member, parts of the outer member work as the insulating members, and the electric fields are generated by the displacement current applied to the insulating members.

Meanwhile, when the transmitting electrodes are provided at the exterior of the outer member, the transmitting apparatus includes coating members for coating the transmitting apparatus together with the transmitting electrodes. In this case, parts of the coating members work as the insulating members, and the electric fields are generated by the displacement current applied to the insulating members.

The transmitting apparatus intercepts low frequency electric signals (S1340).

Since the insulating members have impedance lower than a predetermined value at a frequency higher than a predetermined frequency, the impedance can be reduced by properly adjusting the frequency. In other words, since the insulating members have high impedance at a frequency lower than the predetermined frequency, the insulating members can serve as high pass filters.

The transmitting apparatus transmits the electric signals whose the low frequency electric signals have been intercepted to the receiving electrodes provided at the exterior of the medium (S1350).

The transmitting apparatus transmits the electric signals to the receiving electrodes through the electric fields generated by the insulating members. In this case, plural receiving electrodes are preferred and the plural receiving electrodes have respective different voltages.

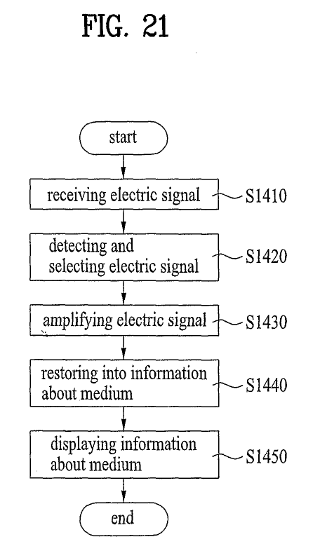

The communication method using a medium according to another embodiment of the present invention will be described in detail with reference to FIG. 21 as follows.

The receiving electrodes receive the electric signals from the transmitting apparatus (S1410).

For example, the receiving electrodes receive the electric signals using the electric fields generated by the transmitting apparatus. The receiving electrodes are attached to the outer side of the medium and transmit the electric signals to the exterior receiving apparatus. In this case, if plural receiving electrodes are provided, the plural receiving electrodes have respective different voltages.

The receiving apparatus detects and selects the electric signals received through the receiving electrodes (S1420).

For example, in a case of plural electric signals, the receiving apparatus selects a specific electric signal from the plural electric signals. Particularly, the receiving apparatus amplifies the plural electric signals differentially to acquire clearer signal.

The receiving apparatus amplifies the selected electric signal (S1430).

The receiving apparatus restores the amplified electric signal into the information about the medium before the conversion (S1440).

The receiving apparatus displays the restored information about the medium (S1450).

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

### INDUSTRIAL APPLICABILITY

According to the present invention, the electric signals can be transmitted using the electric fields without direct flow of electric current. Particularly, simple electrodes can transmit the electric signals to the exterior without additional transmitting antenna.

Moreover, according to the present invention, since low frequencies harmful to the human body are intercepted, high speed communication is enabled at low frequency lower than RF, and an additional RF demodulating module is not required, power consumption is reduced.

Moreover, according to the present invention, the receiving apparatus easily restores the electric signals.

1. A transmitting apparatus using a medium comprising:
an information processing unit for acquiring information about the medium and converting the information into an electric signal;
a transmitting electrode for receiving the electric signal and transmitting the electric signal to a receiving electrode provided at the exterior of the medium; and
an insulating member for forming a capacitor with the transmitting electrode and the medium;
wherein the transmitting electrode transmits the electric signal to the receiving electrode through an electric field generated by the insulating member.

2. The transmitting apparatus using a medium according to claim 1, wherein the medium comprises a human body.

3. The transmitting apparatus using a medium according to claim 1, wherein the information processing unit comprises plural sensors for acquiring the information about the medium.

4. The transmitting apparatus using a medium according to claim 1, wherein the transmitting electrode comprises plural transmitting electrodes and the plural transmitting electrodes have respective different voltages.

5. The transmitting apparatus using a medium according to claim 1, wherein the transmitting electrode comprises a conductive substance.

6. The transmitting apparatus using a medium according to claim 1, wherein the transmitting electrode is provided at any one of the inside and the outside of the transmitting apparatus.

7. The transmitting apparatus using a medium according to claim 6, further comprising an outer member for enclosing internal components of the transmitting apparatus.

8. The transmitting apparatus using a medium according to claim 7, wherein when the transmitting electrode is provided at the inner surface of the outer member, the insulating member comprises a part of the outer member.

9. The transmitting apparatus using a medium according to claim 7, further comprising a coating member for coating overall outer side of the transmitting apparatus.

10. The transmitting apparatus using a medium according to claim 9, wherein when the transmitting electrode is provided at the inner surface of the outer member, the insulating member comprises parts of the outer member and the coating member.

11. The transmitting apparatus using a medium according to claim 9, wherein when the transmitting electrode is provided at the outer surface of the outer member, the insulating member comprises a part of the coating member.

12. The transmitting apparatus using a medium according to claim 1, wherein the receiving electrode is attached to the outer side of the medium and transmits the electric signal to an external receiving apparatus.

13. The transmitting apparatus using a medium according to claim 12, wherein the receiving electrode comprises plural receiving electrodes and the plural receiving electrodes have respective different voltages due to the electric field.

14. The transmitting apparatus using a medium according to claim 1, wherein the insulating member comprises an insulator harmless to the human body.

15. The transmitting apparatus using a medium according to claim 1, comprising a capsule type endoscope for inspecting the inside of the human body.

16. A communication system using a medium comprising:
a transmitting apparatus for converting acquired information about the medium into an electric signal and for transmitting the electric signal to the medium through an electric field generated by an insulating member that forms a capacitor with the medium and the transmitting apparatus; and
a receiving apparatus for detecting the electric signal using plural receiving electrodes provided at the exterior of the medium.

17. The communication system using a medium according to claim 16, wherein the medium comprises a human body.

18. The communication system using a medium according to claim 16, wherein the transmitting apparatus comprises plural sensors for acquiring the information about the medium.

19. The communication system using a medium according to claim 16, wherein the transmitting apparatus comprises plural transmitting electrodes provided at any one of the inside and the outside of the transmitting apparatus.

20. The communication system using a medium according to claim 16, wherein the insulating member comprises a part of any one of an outer member for enclosing inner components of the transmitting apparatus and a coating member for coating overall outer side of the transmitting apparatus.

21. The communication system using a medium according to claim 16, wherein when a transmittal frequency is higher than a predetermined frequency, the insulating member works as a high pass filer so that the transmitting apparatus intercepts low frequencies harmful to a human body.

22. The communication system using a medium according to claim 16, wherein the receiving electrodes are attached to the outer side of the medium.

23. The communication system using a medium according to claim 16, wherein the number of the receiving electrodes is plural and the plural receiving electrodes have respective difference voltages due to the generated electric field.

24. The communication system using a medium according to claim 16, wherein the receiving apparatus comprises:
a signal processing unit for converting the received electric signal into the information about the medium; and
a display for displaying the information about the medium.

25. A communication method using a medium comprising:
acquiring information about the medium;
converting the acquired information into an electric signal;
generating an electric field between a transmitting electrode and the medium; and
transmitting the electric signal to a receiving electrode provided at the exterior of the medium through the electric field.

26. The communication method using a medium according to claim 25, wherein the acquiring uses plural sensors.

27. The communication method using a medium according to claim 25, wherein the generating uses an insulating member forming a capacitor with the transmitting electrode and the medium.

28. The communication method using a medium according to claim 27, wherein the generating generates the electric field due to a displacement current applied to the insulating member.

29. The communication method using a medium according to claim 25, further comprising intercepting low frequencies harmful to a human body by which the insulating member works as a high pass filter.

30. The communication method using a medium according to claim 25, further comprising:
detecting the electric signal transmitted to the receiving electrode;
restoring the electric signal into the information about the medium; and
displaying the information about the medium.

31. The communication method using a medium according to claim 30, wherein the detecting detects the electric signal by which respective different voltages are applied to the respective plural receiving electrodes.
